(19) United States
(12) Patent Application Publication
(10) Pub. No.: US 2006/0129479 A1
(43) Pub. Date: Jun. 15, 2006

(54) Method and system for auction trading

(75) Inventors: Kulvir Singh Bhogal, Fort Worth, TX (US); Sandeep K. Desai, Cedar Park, TX (US); Ishmael Nizamudeen JR., Pflugerville, TX (US); Rohit R. Sahasrabudhe, Austin, TX (US)

Correspondence Address: Greg Goshorn, P.C., 2110 W. Slaughter lane, SUITE 115-119, AUSTIN, TX, 78748, US

(73) Assignee: INTERNATIONAL BUSINESS MACHINES CORPORATION, ARMONK, NY (US)

(21) Appl. No.: 11/008,795

(22) Filed: Dec. 9, 2004

(51) Int. Cl. G06Q 40/00

(52) U.S. Cl. 705/39

(57) ABSTRACT

Provided is a method and system for auction trading which enables transactions to be time shifted. A first sale transaction of a first participant selling to a second participant for a first price is processed. A second sale transaction of the second participant selling to a third participant for a second price is processed. If the second price is greater than the first price, a portion of the second price corresponding to the first price is paid to the first participant and the remainder of the second price is paid to the second participant. Otherwise, the second price is paid to the first participant.

### TECHNICAL FIELD

The present invention relates generally to electronic commerce and, more specifically, to a method and system for auction trading.

### BACKGROUND OF THE INVENTION

The prior art includes a variety of online marketplaces, including a variety of auction-based marketplaces, which have reduced or eliminated several obstacles to efficient markets. As an example, online markets have largely reduced the impact of “geographic separation.” For instance, a baseball card collector in California can use an appropriate online marketplace to purchase a baseball card from a collector in Florida without necessitating the buyer and seller to engage in face-to-face or telephonic contact. As a result, each buyer is provided with exposure to a greater number of potential sellers, and vice-versa. As a result, improved competition is achieved, providing more economically fair pricing and greater availability of desired goods and services.

However, the prior art has failed to overcome certain other obstacles. In particular, the prior art does not address the obstacle of “time separation” between transactions. For instance, if Participant A sells to Participant B in a first transaction, Participant B is required to pay Participant A before entering into a second transaction in which Participant B will sell to Participant C. Thus, Participant B is unable to use the proceeds of the second transaction to pay for his participation in the first transaction.

Some participants independently overcome the “time separation” obstacle by funding purchase transactions with debt financing obtained independently of the online marketplace, such as may be obtained through a credit card, and paying down the debt financing using the proceeds of a subsequent sale transaction.

It would be desirable for an online marketplace to enable participants to overcome the obstacle of “time separation” by funding a buy transaction with proceeds from a subsequent sale transaction.

### SUMMARY OF THE INVENTION

Provided is a method for auction trading which enables transactions to be time shifted. A first sale transaction of a first participant selling to a second participant for a first price is processed. A second sale transaction of the second participant selling to a third participant for a second price is processed. If the second price is greater than the first price, a portion of the second price corresponding to the first price is paid to the first participant and the remainder of the second price is paid to the second participant. Otherwise, if the second price is less than the first price, the second price is paid to the first participant.

Also provided is a system for auction trading, including a computing system adapted to receive signals carrying parameters for sale transactions and computer-readable instructions stored on the computing system for performing the above-described process.

Also provided is a process for auction trading which facilitates a first participant's sale transaction to a second participant. A financial account is created on a computing system, if said account does not exist. A first participant's sale transaction to a second participant for a first price is provided. A second participant's sale transaction to another participant for another price is provided. Proceeds of the second participant's sale transaction are electronically transferred into the account. From the same account, funds are electronically transferred to the first participant up to the first price.

Also provided is a method for providing services to customers over a network. A first sale transaction of a first customer selling to a second customer for a first price is processed. A second sale transaction of the second customer selling to a third customer for a second price is processed. If the second price is greater than the first price, A portion of the second price corresponding to the first price is paid to the first customer and the remainder of the second price is paid to the second customer. Otherwise, the second price is paid to the first customer.

In the method for providing services, after the first customer has received the first price, the first sale transaction can be fulfilled by the first customer. The remainder of the second price can be paid to the second customer electronically. The second price can be paid to the first customer electronically. The portion of the second price corresponding to the first price can be paid to the first customer electronically. The first sale transaction of the first customer selling to the second customer for the first price can be processed by a

computing device. The second sale transaction of the second customer selling to the third customer for the second price can be processed by a computing device.

### BRIEF DESCRIPTION OF THE DRAWINGS

A better understanding of the present invention can be obtained when the following detailed description of the disclosed embodiments is considered in conjunction with the following drawings, in which:

FIG. 1 is a flowchart showing time shifting achieved using independent debt financing, according to the prior art.

FIG. 2 is a flowchart showing time shifting achieved without using independent financing, according to an embodiment of the present invention.

FIG. 3 is a block diagram showing a networked system for supporting time shifting within an online marketplace, according to an embodiment of the present invention.

FIG. 4 is a flowchart showing time shifting achieved without independent financing using a financial account to support the time shifting, according to an embodiment of the present invention.

### DETAILED DESCRIPTION OF THE FIGURES

Although described with particular reference to a networked system, the claimed subject matter can be implemented in any information technology (IT) system in which time shifting within a marketplace is desirable. Those with skill in the computing arts will recognize that the disclosed embodiments have relevance to a wide variety of computing environments in addition to those described below. In addition, the methods of the disclosed invention can be implemented in software, hardware, or a combination of software and hardware. The hardware portion can be implemented using specialized logic; the software portion can be stored in a memory and executed by a suitable instruction execution system such as a microprocessor, personal computer (PC) or mainframe.

In the context of this document, a “memory” or “recording medium” can be any means that contains, stores, communicates, propagates, or transports the program and/or data for use by or in conjunction with an instruction execution system, apparatus or device. Memory and recording medium can be, but are not limited to, an electronic, magnetic, optical, electromagnetic, infrared or semiconductor system, apparatus or device. Memory and recording medium also includes, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored.

Also within the context of this document, a “sale transaction” means any transaction or collection of related transactions entitling one participant (the “seller”) to a reasonably prompt payment or payments from another participant (the “buyer”). The form of payment can include anything of value, although limited by the terms of a particular sale transaction, including, by way of example, currency, credit to account, account receivable, goods, financial instruments, real estate, and leases. The terms of a sale transaction will likely be determined by the governing law, marketplace rules, and buyer-seller agreement. A seller “sells” to a buyer via a sale transaction. As a practical matter, the subject matter of a sale transaction can be anything; subject matter examples include goods, financial instruments, real estate, and leases.

Also within the context of this document, the term “paying” means providing value, including for example, providing currency or electronic funds transfer.

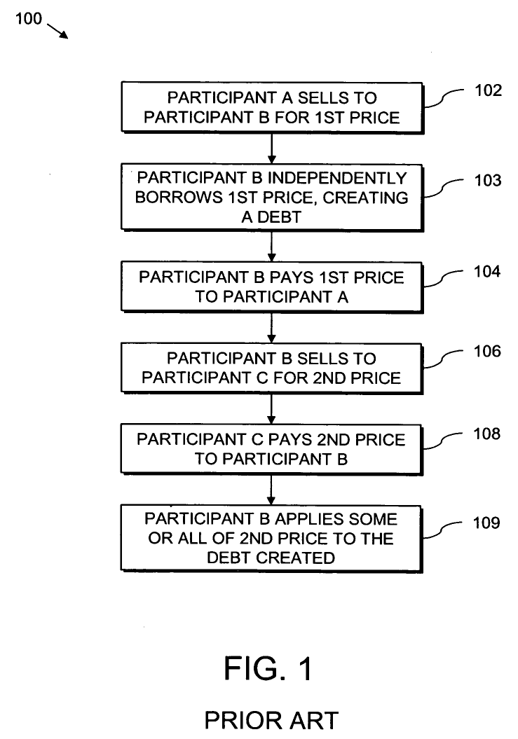

Turning now to the figures, FIG. 1 is a flowchart showing time shifting achieved using independent debt financing, according to the prior art. A process 100 for time shifting with independent debt financing is shown. In a first transaction, Participant A sells 102 to Participant B for a first price. Participant B then borrows 103 funds in the amount of the first price, creating a first debt and initiating time shifting. Participant B uses the borrowed funds to pay 104 Participant A the first price, thereby completing the first transaction. In a second transaction, Participant B sells 106 to Participant C for a second price. Participant B then receives 108 the second price from Participant C, completing the second transaction. Finally, Participant B applies 109 some or all of the received second price to the debt earlier created, thereby completing, in whole or in part, the initiated time shifting. The subject matters of the first and second transactions may be the same, but are typically different.

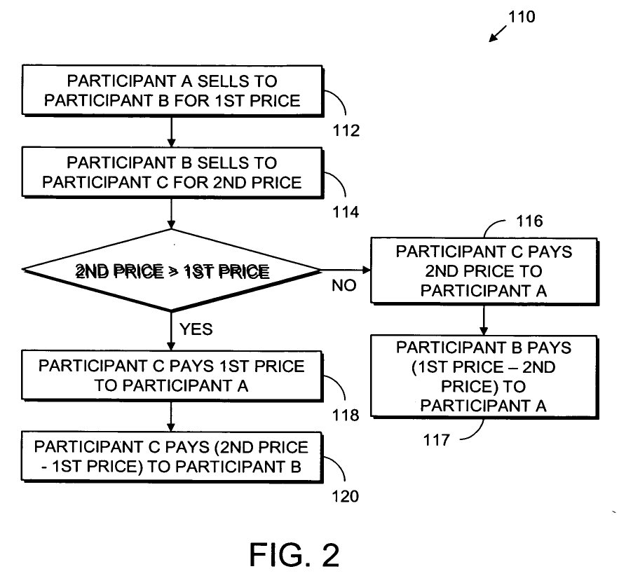

FIG. 2 is a flowchart showing time shifting achieved without using independent financing, according to an embodiment of the present invention. A process 110 for auction pricing internalizes time shifting into an online marketplace. Participant A sells 112 to Participant B for a first price. Participant B sells 114 to Participant A at a second price. If the second price is less than the first price, Participant A receives 116 the second price from Participant C, and Participant B must pay 117 the difference between the first and second prices.

If the second price is greater than the first price, Participant A receives 118 the first price from Participant C, and Participant B receives 120 the difference between the first and second prices. If the first and second prices are equal, Participant A simply receives 118 the first price from Participant C.

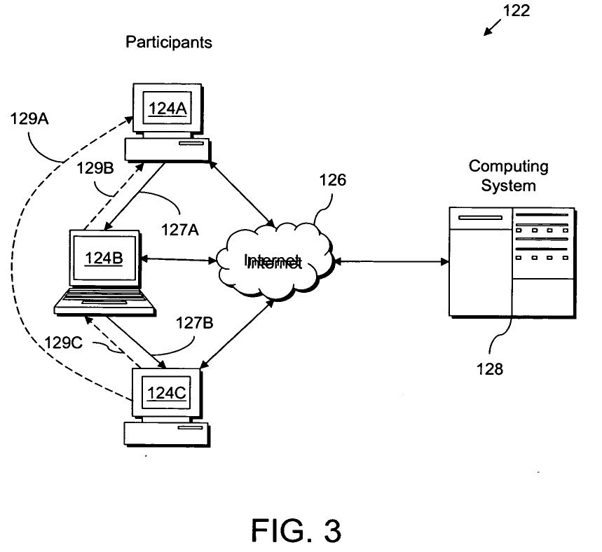

FIG. 3 is a block diagram showing a networked system for supporting time shifting within an online marketplace, according to an embodiment of the present invention. A networked system 122 includes at least three participants 124A, 124B, and 124C, connected over a full time public network 126, such as the Internet, to a computing system 128. A first transaction 127A occurs between the first participant 124A and the second participant 124B at a first price. A second transaction 127B occurs between the second participant 124B and the third participant 124C at a second price. While FIG. 3 depicts the first and second transactions with direct arrows between participants, the transactions are preferably processed through the computing system 128.

The third participant 124C pays 129A the first participant 124A the lesser of the first and second prices. In addition, if the second price is less than the first price, the second participant 124B pays 129B the first participant 124A the difference between the first and second prices. Alternately, if the second price exceeds the first price, the third participant 124C pays 129C the second participant 124B the difference between the first and second prices.

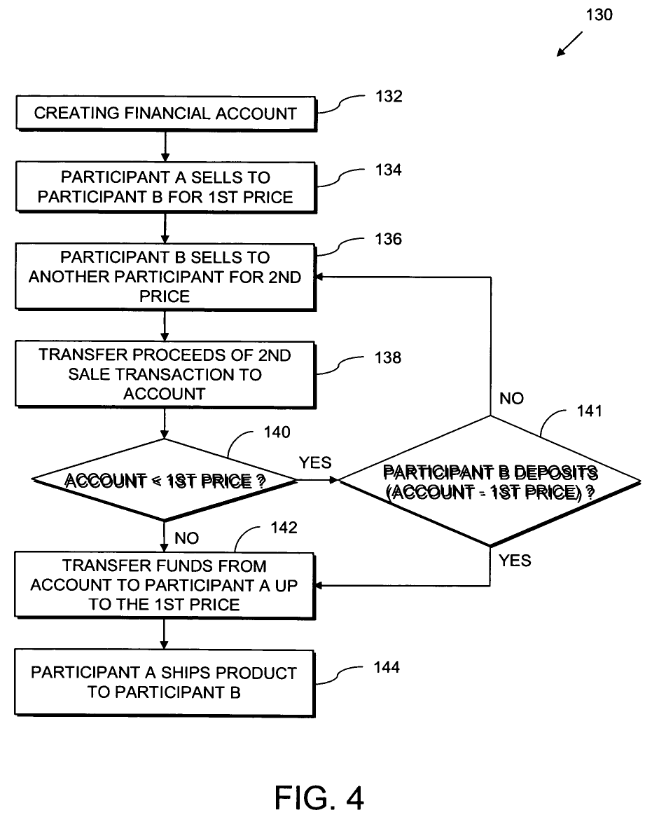

FIG. 4 is a flowchart showing time shifting achieved without independent financing using a financial account to support the time shifting, according to an embodiment of the present invention. A process 130 is depicted for creating and using such a financial account. A financial account is created 132, preferably on a computing system. Participant A sells 134 to Participant B for a first price. Participant B sells 136 to another participant for another price, the proceeds of which are electronically transferred 138 into the financial account. If the financial account balance is less than the first sale transaction price 140, Participant B either deposits 141 funds into the financial account sufficient to make the financial account's balance equal to or greater than the first sale transaction price or steps 136, 138, and 140 are repeated in that Participant B sells to yet another participant for yet another price. If the financial account balance is not less than the first sale transaction price 140, funds are transferred 142 from the financial account to Participant A up to the first price. Finally, Participant A fulfills the first sale transaction; for example, Participant A may be required to ship 144 a purchased good to Participant B.

As will be understood by those skilled in the art, an alternate embodiment provides that proceeds corresponding to multiple sale transactions by Participant B can be added to the account until the Participant A is fully reimbursed for the first sale transaction. Preferably, the financial account established for accumulating the proceeds of one or more Participant B sale transaction is not “owned” by Participant B, at least in the sense that Participant B lacks the ability and legal right to withdraw funds from the account at least until the first price is paid to Participant A. Furthermore, it is preferable that the proceeds of Participant B's sale transactions remain completely free of Participant B's possession until Participant A has been fully paid for the first sale transaction. Accordingly, it is preferable that the proceeds of Participant B's sale transactions be deposited directly into the financial account by the other participant(s) instead of being given to Participant B.

In the embodiment disclosed in FIG. 4, Participant A is not required to fulfill 144 the first transaction until proceeds have been received. As those skilled in the art will appreciate, terms of sales transactions can vary widely within the scope of the invention as defined by the appended claims. Furthermore, methods and systems for auction trading, as disclosed, can be implemented for any type of market structure. Some common examples of market structures are fixed bid, English auction, Dutch auction, sealed bid auction, reverse auction, call auction, double continuous exchange, and call market exchange.

In embodiments of methods for providing services to customers, customers of such embodiments can correspond to participants of other embodiments.

While the invention has been shown and described with reference to particular embodiments thereof, it will be understood by those skilled in the art that the foregoing and other changes in form and detail may be made therein without departing from the spirit and scope of the invention, including but not limited to additional, less or modified elements and/or additional, less or modified blocks performed in the same or a different order. For example, restrictions on a particular participant's trading activity may be imposed to reduce the likelihood that the participant will fail to meet the terms of time shifted sale transactions which have already been agreed. As another example, marketplace rules may prohibit or restrict the terms of time shift purchasing of certain items, such as those bearing a “reserve” price.

We claim:

1. A method for auction trading, comprising the steps of:
processing a first sale transaction of a first participant selling to a second participant for a first price;
processing a second sale transaction of the second participant selling to a third participant for a second price;
if the second price is greater than the first price, paying a portion of the second price corresponding to the first price to the first participant and paying the remainder of the second price to the second participant; and
otherwise, paying the second price to the first participant.

2. The method of claim 1, further comprising the steps of:
processing a third sale transaction of the third participant selling to a fourth participant for a third price;
if the third price is greater than the second price, paying a portion of the third price corresponding to the second price to the second participant and paying the remainder of the third price to the third participant; and
otherwise, paying the third price to the second participant.

3. The method of claim 1, further comprising the step of:
after the first participant has received the first price, fulfilling of the first sale transaction by the first participant.

4. The method of claim 1,
wherein paying the remainder of the second price to the second participant comprises electronically paying the remainder of the second price to the second participant;
wherein paying the second price to the first participant comprises electronically paying the second price to the first participant; and
wherein paying the portion of the second price corresponding to the first price to the first participant comprises electronically paying the portion of the second price corresponding to the first price to the first participant.

5. The method of claim 1,
wherein the step of processing the first sale transaction of the first participant selling to the second participant for the first price comprises the step of processing by a computing device the first sale transaction of the first participant selling to the second participant for the first price comprises; and
wherein the step of processing the second sale transaction of the second participant selling to the third participant for the second price comprises the step of processing by the computing device the second sale transaction of the second participant selling to the third participant for the second price.

6. A system for auction trading, comprising:
a computing system including:
a processor;
a memory operably coupled to the processor;
a network interface operably coupled to the processor;
wherein the computing system is adapted to receive from a network signals carrying parameters for sale transactions;
wherein the computing system is further adapted to process a first sale transaction of a first participant selling to a second participant for a first price;
wherein the computing system is further adapted to process a second sale transaction of the second participant selling to a third participant for a second price;
wherein the computing system is further adapted to, if the second price is greater than the first price, pay a portion of the second price corresponding to the first price to the first participant and pay the remainder of the second price to the second participant, and otherwise, pay the second price to the first participant.

7. The system of claim 6,
wherein the computing system is further adapted to process a third sale transaction of the third participant selling to a fourth participant for a third price; and
wherein the computing system is further adapted to if the third price is greater than the second price, pay a portion of the third price corresponding to the second price to the second participant and pay the remainder of the third price to the third participant, and otherwise, pay the third price to the second participant.

8. The system of claim 6, wherein the computing system is further adapted to, after the first participant has received the first price, fulfill the first sale transaction by the first participant.

9. The system of claim 6,
wherein the computing system is further adapted to electronically pay the remainder of the second price to the second participant;
wherein the computing system is further adapted to electronically pay the second price to the first participant; and
wherein the computing system is further adapted to electronically pay the portion of the second price corresponding to the first price to the first participant.

10. The system of claim 6, wherein the computing system is further adapted to electronically create a financial account, if said account does not exist, and, after processing the second sale transaction, electronically transfer proceeds of the second sale transaction into the account.

11. The system of claim 6, wherein the computing system is further adapted to communicably facilitate the second participant electronically transferring funds into the financial account equal to the amount by which the first price exceeds the financial account.

12. The system of claim 6, wherein the computing system is further adapted to repeatedly, while the financial account balance is less than the first price, provide the second participant's sale transaction to another participant for another price and electronically transfer proceeds of the second participant's sale transaction into the financial account.

13. The system of claim 6, wherein the computing system is further adapted to electronically transfer funds from the financial account to the first participant up to the first price only after the financial account balance is equal to or greater than a predetermined threshold.

14. The system of claim 13, wherein the predetermined threshold is equal to the first price.

15. A computer programming product for auction trading which facilitates a first participant's sale transaction to a second participant, comprising:
a memory;
logic, stored on the memory, for:
creating a financial account on a computing system, if said account does not exist;
providing data corresponding to a first participant's sale transaction to a second participant for a first price;
providing data corresponding to a second participant's sale transaction to another participant for another price;
electronically transferring proceeds of the second participant's sale transaction into the account; and
electronically transferring funds from the account to the first participant up to the first price.

16. The product of claim 17, further comprising logic for:
enabling the second participant to electronically transfer funds into the account equal to the amount by which the first price exceeds the account.

17. The product of claim 17, further comprising logic for:
while the account balance is less than the first price, repeating the steps of:
providing the second participant's sale transaction to another participant for another price; and
electronically transferring proceeds of the second participant's sale transaction into the account.

18. The product of claim 17, wherein the logic is configured such that electronically transferring funds from the account to the first participant up to the first price occurs only after the account balance is equal to or greater than a predetermined threshold.

19. The product of claim 20, wherein the logic is configured such that the predetermined threshold is equal to the first price.

20. The product of claim 17, further comprising logic for:
enabling the first and second participants to view financial information regarding the account.

21. A method for providing services to customers over a network, the service comprising:
processing a first sale transaction of a first customer selling to a second customer for a first price;
processing a second sale transaction of the second customer selling to a third customer for a second price;
if the second price is greater than the first price, paying a portion of the second price corresponding to the first price to the first customer and paying the remainder of the second price to the second customer; and
otherwise, paying the second price to the first customer.

22. The method of claim 21, further comprising the steps of:
processing a third sale transaction of the third customer selling to a fourth customer for a third price;
if the third price is greater than the second price, paying a portion of the third price corresponding to the second price to the second customer and paying the remainder of the third price to the third customer; and
otherwise, paying the third price to the second customer.

23. The method of claim 21, further comprising the step of:
after the first customer has received the first price, fulfilling of the first sale transaction by the first customer.

24. The method of claim 21,
wherein paying the remainder of the second price to the second customer comprises electronically paying the remainder of the second price to the second customer;
wherein paying the second price to the first customer comprises electronically paying the second price to the first customer; and
wherein paying the portion of the second price corresponding to the first price to the first customer comprises electronically paying the portion of the second price corresponding to the first price to the first customer.

25. The method of claim 21,
wherein the step of processing the first sale transaction of the first customer selling to the second customer for the first price comprises the step of processing by a computing device the first sale transaction of the first customer selling to the second customer for the first price comprises; and
wherein the step of processing the second sale transaction of the second customer selling to the third customer for the second price comprises the step of processing by the computing device the second sale transaction of the second customer selling to the third customer for the second price.
